(19) United States
(12) Patent Application Publication
(10) Pub. No.: US 2026/0085718 A1
(43) Pub. Date: Mar. 26, 2026

(54) ARTICULATED CONNECTOR DEVICE, AND PADDING HOLDER WITH AN ARTICULATED CONNECTOR DEVICE OF THIS TYPE

(71) Applicant: HOGGI GmbH, Ransbach-Baumbach (DE)

(72) Inventor: Gregor Horacek, Ransbach-Baumbach (DE)

(21) Appl. No.: 19/338,888

(22) Filed: Sep. 24, 2025

(30) Foreign Application Priority Data
Sep. 25, 2024 (EP) 24202457.8

(51) Int. Cl. F16C 11/10; A61G 5/10; A61G 5/12; F16B 2/10

(52) U.S. Cl. CPC F16C 11/103; A61G 5/1043; A61G 5/12; F16B 2/10

(57) ABSTRACT

A padding holder with an articulated connector device is disclosed. The connector device has a first joint arm, a second joint arm and a connecting arm, wherein the first joint arm has a first bearing portion and is mounted with its first bearing portion in the connecting arm pivotably about a first pivot axis, wherein the second joint arm has a second bearing portion and is mounted with its second bearing portion in the connecting arm pivotably about a second pivot axis, wherein the first pivot axis and the second pivot axis run parallel, wherein the connector device has a clamping unit mounted in the connecting arm, wherein the clamping unit has a front clamping jaw and a rear clamping jaw that can be fed in towards one another along an infeed direction for fixing the joint arms in their respective pivot position with respect to the connecting arm.

### CROSS-REFERENCE TO RELATED APPLICATION

This application claims priority of European Patent Application No. 24202457.8 filed Sep. 25, 2024, the entire content of which is incorporated herein by reference.

### TECHNICAL FIELD

The invention relates to an articulated connector device. Furthermore, the invention relates to a padding holder with an articulated connector device of this type.

### BACKGROUND

Paddings, for example paddings attached to wheelchairs, serve to stabilize and guide the user. They correct, guide and support physically impaired persons who, as a result of various impairments, cannot hold one or more body parts themselves and/or have a limited muscle tone for the corresponding body part.

There are different types and shapes of paddings such as, for example, thorax paddings, head support paddings or paddings for supporting pelvises or thighs.

Paddings of this type are typically fastened by way of padding holders to wheelchairs, beds, chairs or other assistive devices for the impaired persons. Padding holders of this type are as a rule adjustable, in order to establish, as a result of adjustment of the padding holder, optimum positioning and/or orientation with respect to the person, in particular with regard to the body part to be stabilized such as, for example, the head. After setting up the padding holder, it is necessary to fix the padding holder in the corresponding position.

Padding systems with padding holders for supporting body parts are known, in particular, in the field of rehabilitation technology.

A seat shell for disabled persons, in particular for disabled children and adolescents, with adjustable paddings is known, for example, from DE 20 2007 013 812 U1.

Padding holders known from the prior art often have an articulated, in particular double-jointed, connector device. As a rule, the connector device has a first joint arm, a padding which is connected to the first joint arm, a second joint arm with a fastening device, and a connecting arm, wherein the first joint arm is mounted by way of its bearing portion in the connecting arm pivotably about a first pivot axis, and wherein the second joint arm has a second bearing portion, wherein the second joint arm is mounted by way of its second bearing portion in the connecting arm pivotably about a second pivot axis, wherein the first pivot axis and the second axis run parallel to one another. Via the fastening device, the padding holder can be fastened, for example, to a subframe of a wheelchair. Via the articulated connector device, setting up or orienting of the padding with respect to the persons using the wheelchair can take place. Following setting up, the first joint arm and the second joint arm have to be fixed in the set-up pivot position with respect to the connecting arm, in order that the set orientation of the padding with respect to the persons utilizing the wheelchair is kept permanently stable.

It is a problem in the case of the known connector device that a plurality of steps and, in particular, separate steps per joint arm are frequently necessary for positionally stable fixing of the joint arms to the connecting arm. In the case of connected devices known from the prior art, it has been shown in addition that a multiplicity of operating actions are necessary in order to achieve high clamping forces for positionally stable securing of the joint arms, for example tightening of a plurality of different clamping screws.

### SUMMARY

It is an object of the present invention to provide an articulated connector device which overcomes the abovementioned disadvantages. Furthermore, it is an object of the present invention to specify a padding holder which is improved in this regard.

These objects are achieved by the subjects of the independent claims. The dependent claims relate to advantageous developments.

The articulated connector device according to the invention is used, in particular, in a padding holder.

It is provided that the connector device has a first joint arm, a second joint arm and a connecting arm, wherein the first joint arm has a first bearing portion, wherein the first joint arm is mounted by way of its first bearing portion in the connecting arm pivotably about a first pivot axis, and wherein the second joint arm has a second bearing portion, wherein the second joint arm is mounted by way of its second bearing portion in the connecting arm pivotably about a second pivot axis, wherein the first pivot axis and the second pivot axis run parallel to one another.

The connector device has a clamping unit, wherein the clamping unit is mounted in the connecting arm, wherein the clamping unit has a front clamping jaw and a rear clamping jaw, wherein the clamping jaws can be fed in towards one another along an infeed direction for fixing the first joint arm and the second joint arm in their respective pivot position with respect to the connecting arm.

The first bearing portion has a convexly curved first clamping surface which runs concentrically with respect to the first pivot axis, wherein the front clamping jaw has a first mating clamping surface and the rear clamping jaw has a further first mating clamping surface, wherein the first mating clamping surface and the further first mating clamping surface are each concavely curved in a complementary manner with respect to the first clamping surface, in such a way that, when the clamping jaws are fed in towards one another, the first mating clamping surface and the further first mating clamping surface come into contact in each case over their full area with the first clamping surface and interact in a non-positive manner with the latter for fixing the first joint arm such that it cannot rotate with respect to the connecting arm.

The second bearing portion has a convexly curved second clamping surface which runs concentrically with respect to the second pivot axis, wherein the front clamping jaw has a second mating clamping surface, and the rear clamping jaw has a further second mating clamping surface, wherein the second mating clamping surface and the further second mating clamping surface are concavely curved in each case in a complementary manner with respect to the second clamping surface, in such a way that, when the clamping jaws are fed in towards one another, the second mating clamping surface and the further second mating clamping surface come into contact in each case over their full area with the second clamping surface and interact in a non-positive manner with the latter fixing the second joint arm such that it cannot rotate with respect to the connecting arm.

In the case of the articulated connector device according to the invention, in order to fix the first joint arm and the second joint arm, it is merely necessary for the clamping jaws to be fed in towards one another. The front clamping jaw and the rear clamping jaw act both on the first bearing portion and on the second bearing portion, with the result that, as a result of the clamping jaws being fed in towards one another, the two bearing portions are fixed in a non-positive or frictionally locking manner between the clamping jaws such that they cannot rotate, and are therefore fixed such that they cannot rotate with respect to the connecting arm on account of the mounting of the clamping unit in the connecting arm.

It is certainly conceivable that the first joint arm and/or the second joint arm are/is likewise configured as a further connecting arm with a clamping unit, in order to form a connector device with more than two pivot axes. Furthermore, it is also conceivable that the first joint arm and/or the second joint arm are/is connected pivotably to a further connecting arm, wherein a further clamping unit is mounted in the further connecting arm, in order to form a connector device with more than two pivot axes, for example with four pivot axes. The further pivot axes formed by the respective further connecting arm are preferably configured parallel to the first pivot axis and the second pivot axis.

A spacing of the first pivot axis from the second pivot axis is preferably from 20 mm to 150 mm, in particular from 20 mm to 100 mm.

It is considered to be particularly advantageous if, in a cross section perpendicularly with respect to the pivot axes, the first clamping surface, the first mating clamping surface and the further first mating clamping surface each describe a circular arc with an identical first radius, and/or, in a cross section perpendicularly with respect to the pivot axes, the second clamping surface, the second mating clamping surface and the further second mating clamping surface each describe a circular arc with an identical second radius. As a result, a great non-positive connection with an infinitely variable pivot angle adjustment is made possible.

It is considered to be particularly advantageous if the first radius and the second radius are of equal magnitude.

The first radius is preferably from 5 mm to 20 mm. The second radius is preferably from 5 mm to 20 mm.

It is provided in one particularly preferred development that the first clamping surface and/or the second clamping surface are/is of convex-cylindrical configuration. Accordingly, it is likewise considered to be advantageous if the first mating clamping surface, the further first mating clamping surface, the second mating clamping surface and the further second mating clamping surface are of concave-cylindrical configuration.

The first clamping surface and/or the second clamping surface advantageously have/has a centre angle of greater than or equal to 90°, preferably greater than or equal to 150°, particularly preferably of greater than or equal to 180°. A great angular adjustment range can be achieved as a result.

In order to achieve a particularly compact design with a nevertheless satisfactory clamping force, it is provided in one advantageous development that a sum of the centre angles of the circular arcs described by the first mating clamping surface and the further first mating clamping surface is smaller than 180°, is preferably smaller than 120°, is particularly preferably smaller than 100°, is preferably smaller than 90°, in particular is smaller than 60°, and/or a sum of the centre angles of the circular arcs described by the second mating clamping surface and the further second mating clamping surface is smaller than 180°, is preferably smaller than 120°, is particularly preferably smaller than 100°, is preferably smaller than 90°, in particular is smaller than 60°.

In one preferred embodiment, the sum of the centre angles of the circular arcs described by the first mating clamping surface and the further first mating clamping surface is greater than 10°, and/or a sum of the centre angles of the circular arcs described by the second mating clamping surface and the further second mating clamping surface is greater than 10°.

It has been shown in practice that it is not necessary that the mating clamping surfaces engage around the respective bearing portion by more than 180°, if ends facing away from one another of the mating clamping surfaces which are assigned to the respective bearing portion enclose an angle of more than 180°in relation to the respective pivot axis of the bearing portion. Rather, it has been shown that an angle which is enclosed by the ends can be considerably smaller than 180°, and a sufficient non-positive connection can nevertheless be achieved. It is considered to be particularly advantageous if the angle which is enclosed by the ends which face away is smaller than 180°, in particular is between 20°and 100°.

It is provided in one particularly preferred embodiment that the connecting arm has an upper portion, and a lower portion which is spaced apart along the axial direction of the pivot axes, and a connecting portion which connects the upper portion to the lower portion.

It is considered to be particularly advantageous, however, if the connecting arm is open on a side which lies opposite the connecting portion in the infeed direction. As a result, the mounting of the articulated connector device is facilitated.

In conjunction with the connecting portion, it is considered to be particularly advantageous if the rear clamping jaw is received captively between the first bearing portion, the second bearing portion, the upper portion, the lower portion and the connecting portion.

A design of this type is to be considered to be advantageous with respect to the fact that the rear clamping jaw can be designed in such a way that it is configured as a separate element, to that extent is not connected to the connecting arm in a stationary manner, and is nevertheless mounted captively in the connecting arm.

In this context, it is considered to be particularly advantageous if the rear clamping jaw is received in a floating manner between the first bearing portion, the second bearing portion, the upper portion, the lower portion and the connecting portion.

A design of this type is to be considered to be advantageous with respect to the fact that, in the case of tolerance-induced deviations, secure non-positive fixing of the respective bearing portion by means of the clamping unit is nevertheless made possible, since, on account of the floating mounting, the clamping jaws can compensate for tolerance-induced deviations by way of a positional change in the connecting arm.

Furthermore, floating mounting is to be considered to be advantageous with respect to the fact that wear occurs on the clamping surfaces and/or the mating clamping surfaces in the case of the use of the articulated connector device.

It is provided in one particularly preferred embodiment that the front clamping jaw and the rear clamping jaw are designed in such a way that the front clamping jaw and the rear clamping jaw are spaced apart from one another in the infeed direction in the position, in which they are fed in towards one another.

This ensures that the front clamping jaw and the rear clamping jaw are supported along the infeed direction exclusively on the bearing portions are not, directly or indirectly, on one another and/or on the connecting arm. The design of this type ensures that the desired non-positive connection between the clamping surfaces and the mating clamping surfaces for the purpose of a non-positive connection and, due to this, fixing such that they cannot rotate occurs when the clamping jaws are fed in towards one another.

It is considered to be particularly advantageous if there is a gap between the front clamping jaw and the rear clamping jaw in the position of the clamping jaws, in which they are fed in towards one another, wherein, in a cross section perpendicularly with respect to the pivot axes, a first end portion of the gap which adjoins the first bearing portion and a second end portion of the gap which adjoins the second bearing portion lie on a connecting line between the first pivot axis and the second pivot axis. This can achieve a particularly great and uniform non-positive connection to the two bearing portions.

The connecting line preferably runs perpendicularly with respect to the infeed direction of the clamping jaws.

That region of the first mating clamping surface which adjoins the gap, that region of the second mating clamping surface which adjoins the gap, that region of the further first mating clamping surface which adjoins the gap, and that region of the further second mating clamping surface which adjoins the gap preferably each enclose an angle with the infeed direction of from 0° to 5°. As a result, particularly high pressing forces can be brought about on the clamping surfaces of the bearing portions when the clamping jaws are fed in. In addition, as a result, a self-locking action can be achieved in that position of the clamping jaws, in which they are fed in towards one another.

The first and the second clamping surfaces, the first and the second mating clamping surfaces, and the further first and the further second mating clamping surfaces are preferably designed in such a way that the bearing portions are pressed in directions which oppose one another when the clamping jaws are fed in towards one another.

With regard to the infeed direction of the clamping jaws, furthermore, it is considered to be advantageous if the infeed direction runs perpendicularly with respect to a plane which is defined by the pivot axes.

It is considered to be particularly advantageous if the clamping unit has a screw connection which acts between the front clamping jaw and the rear clamping jaw for feeding in the clamping jaws towards one another by tightening the screw connection.

It is provided in one particularly preferred embodiment that the screw connection has at least one screwing element with a threaded portion, wherein one clamping jaw of the clamping jaws has at least one mating threaded portion, to which the at least one screwing element is screwed by way of its threaded portion.

The at least one screwing element is preferably arranged between the first pivot axis and the second pivot axis. As a result, force is exerted on the two bearing portions when the screwing element or the screwing elements is/are tightened.

It is considered to be particularly advantageous if the screw connection has a single screwing element. As a result, the clamping unit can be fed in and can be opened particularly rapidly by tightening and releasing the one single screwing element.

The screw connection can also, however, comprise a plurality of spring elements, for example two screwing elements.

If, in particular, the pivot axes are at a relatively great spacing, for example of greater than 50 mm, it is considered to be advantageous if the screw connection comprises a plurality of spring elements, in order to obtain a high clamping force and therefore a high non-positive connection on the two bearing portions, wherein at least one of the plurality of screwing elements is configured adjacently with respect to the bearing portion and another of the plurality of spring elements is configured adjacently with respect to the second bearing portion.

It is provided in one advantageous development that the at least one screwing element is configured with a screw with an external thread as threaded portion, and the at least one mating threaded portion of the one clamping jaw is configured as an internal thread, wherein the at least one screw passes through the other clamping jaw.

As an alternative, it is fundamentally conceivable that the one of the clamping jaws has at least one threaded rod which passes through the other clamping jaw and has an external thread, wherein the at least one screwing element has an internal thread, for example is configured as a nut.

The one clamping jaw is preferably the front clamping jaw. The other clamping jaw is accordingly preferably the rear clamping jaw.

The rear clamping jaw preferably has at least one through opening, for example in the form of a bore, wherein the at least one screwing element passes through the rear clamping jaw.

It is considered to be particularly advantageous if, in a cross section perpendicularly with respect to the pivot axes, the one clamping jaw has a greater material thickness in the region of the at least one internal thread than in the adjoining regions. As a result, a particularly compact design of the connected device with regard to the extent of the clamping unit in the direction of the infeed direction of the clamping unit or the clamping jaws can be achieved, and a sufficiently large threaded portion can nevertheless be provided. In addition, it can be achieved as a result that the end portions of the gap lie on the connecting line between the pivot axes of the bearing portions, in order to bring the full area of the clamping surfaces into contact with all mating clamping surfaces.

In this context, it is considered to be particularly advantageous if, in a cross section perpendicularly with respect to the pivot axes, the one clamping jaw has a projection in the region of the at least one internal thread on its side which faces the other clamping jaw, and the other clamping jaw has a recess which corresponds to the projection.

It is provided in one particularly preferred embodiment that the screw connection is designed in such a way that, when the screw connection is tightened, exclusively the front clamping jaw and the rear clamping jaw are fed in relative to one another, in particular in such a way that no supporting of the clamping unit or components of the clamping unit occurs on the connecting arm and/or the clamping jaws on one another.

Against this background, in particular, it is considered to be advantageous if the clamping unit including the screw connection is mounted in a floating manner in the connecting arm.

It is provided in one advantageous development that the clamping unit can be preassembled via the screw connection, in order to produce a preassembled assembly unit, wherein this preassembled assembly unit comprises the front clamping jaw, the rear clamping jaw and the screw connection, for example in the form of a screw. A preassembled assembly unit of this type facilitates the final assembly of the articulated connector device. For example, in a first step, the first joint arm can be connected via its first bearing portion to the connecting arm. This can take place, for example, by virtue of the fact that the first bearing portion has a through bore, wherein this through bore serves to receive a cylindrical pin, wherein the cylindrical pin is pressed into the through bore by means of an undersized fit. Furthermore, the cylindrical pin is received in the connecting arm rotatably about the first pivot axis, for example is mounted in through bores of the connecting arm. Subsequently, the preassembled clamping unit is inserted into the connecting arm, wherein the clamping jaws are not fed in towards one another and there is a sufficient clearance between the clamping jaws, in order to arrange the first mating clamping surface and the further first mating clamping surface on the first bearing portion which has already been assembled, and to introduce the second bearing portion between the second mating clamping surface and the further second mating clamping surface, with the result that this second bearing portion is positioned correctly with respect to the connecting arm, in order to secure the second bearing portion in the connecting arm via a cylindrical pin which passes through the connecting arm, such that it is pivotably movable about the second pivot axis.

The padding holder according to the invention comprises the articulated connector device according to the invention. It is provided here that the first pivot arm has a padding or is connected to a padding, wherein the second pivot arm has a fastening device for fastening the padding holder to a frame, for example for fastening the padding holder to a frame of a wheelchair.

Since the padding holder comprises the articulated connector device according to the invention, the comments in respect of the advantages and advantageous developments of the articulated connector device apply correspondingly to the padding holder, and vice versa.

### BRIEF DESCRIPTION OF DRAWINGS

In the following figures, the invention will be explained in greater detail on the basis of exemplary embodiments, without being restricted to the latter. In the figures:

FIG. 1 shows a padding holder with an articulated connector device in accordance with a first embodiment in a perspective illustration,

FIG. 2 shows the articulated connector device of the padding holder according to FIG. 1 in a perspective illustration,

FIG. 3 shows the articulated connector device according to FIG. 2 in a view according to the arrow III in FIG. 4,

FIG. 4 shows the articulated connector device in a sectional view according to the line A-A in FIG. 3,

FIG. 4A shows a part region of FIG. 4 in an enlarged illustration,

FIG. 5 shows the articulated connector device according to FIG. 3 in an exploded illustration,

FIG. 6 shows a clamping unit of the connector device according to FIG. 2 in a preassembled state,

FIG. 7 shows an articulated connector device in accordance with a second embodiment in a perspective illustration,

FIG. 8 shows a second joint arm of the connector device according to FIG. 7,

FIG. 9 shows an articulated connector device in accordance with a third embodiment in a view according to the arrow IX in FIG. 10, and

FIG. 10 shows the articulated connector device in a sectional view according to the line A-A in FIG. 9.

### DETAILED DESCRIPTION

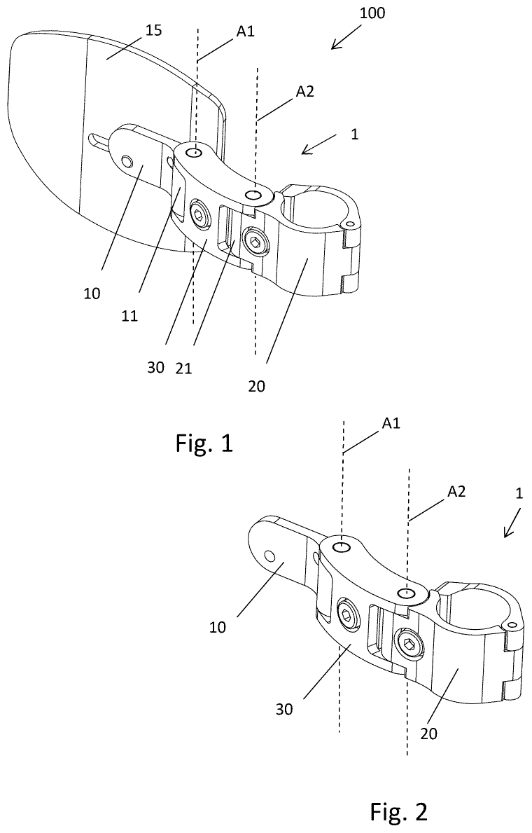

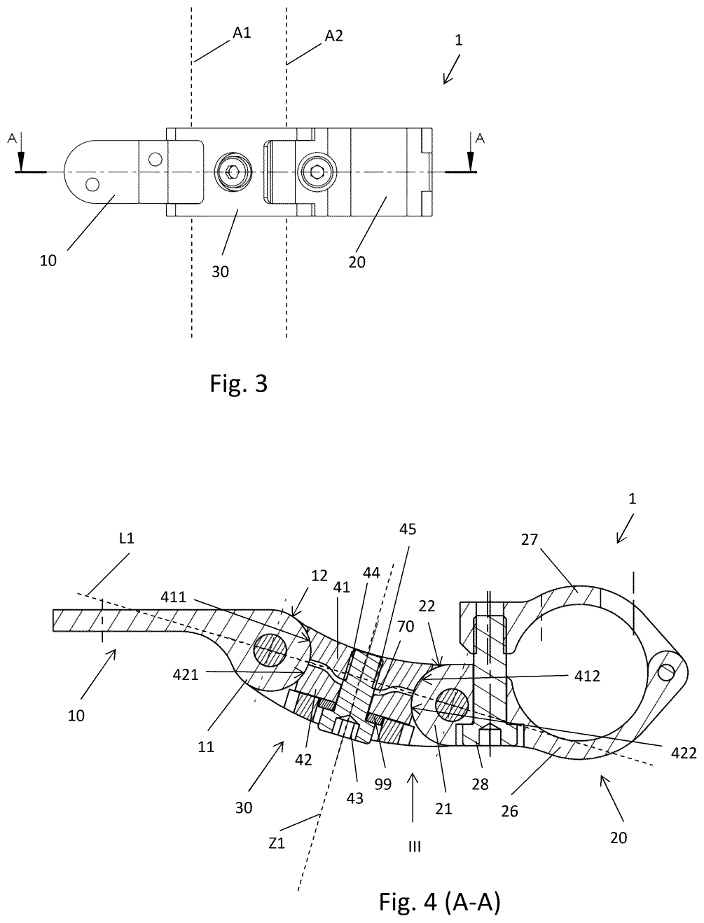

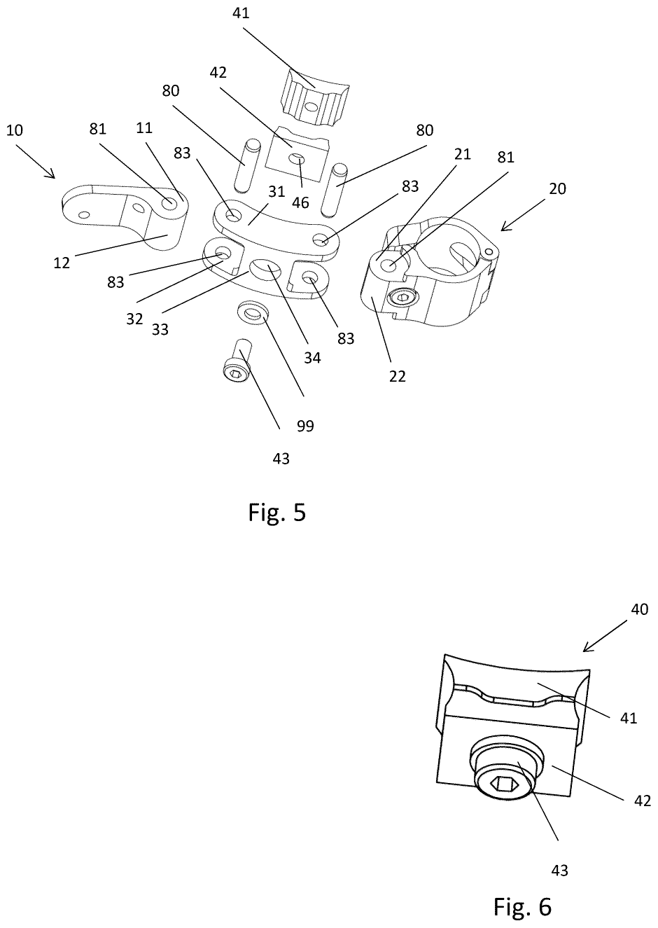

FIGS. 1 to 6 show a first embodiment of an articulated connector device 1 and constituent parts of the articulated connector device 1. FIG. 1 shows a padding holder 100. The padding holder 100 comprises a first embodiment of the articulated connector device 1 which is configured in the present case as a double-jointed connector device. The articulated connector device 1 comprises a first pivot arm 10, a second pivot arm 20 and a connecting arm 30. A padding 15 is attached to the first joint arm 10. Another material element can certainly be connected to this padding 15.

The first joint arm 10 has a first bearing portion 11, wherein the first joint arm 10 is mounted by way of its first bearing portion 11 in the connecting arm 30 pivotably about a first pivot axis A1.

The second joint arm 20 has a second bearing portion 21, wherein the second joint arm 20 is mounted by way of its second bearing portion 21 in the connecting arm 30 pivotably about a second pivot axis A2.

The first pivot axis A1 and the second pivot axis A2 are spaced apart from one another and run parallel to one another.

The respective bearing portion 11, 12 is mounted via a cylindrical pin 80 in the connecting arm 30 pivotably about the respective pivot axis A1, A2. For this purpose, the respective cylindrical pin 80 passes through a corresponding through bore 81 of the respective bearing portion 11, 21 and is pressed into this through bore 81 by means of an undersized fit. The cylindrical pin 80 is received rotatably in corresponding through bores 83 of the connecting arm 30, in order to make the pivoting about the respective pivot axis A1, A2 possible.

The second joint arm 20 is configured as a frame clamp, and has a joint clamping half 26 and a tensioning clamping half 27 and a bracing screw 28. The frame clamp is designed in such a way that a rod can be introduced between the joint clamping half 26 and the tensioning clamping half 27 and can be held in a clamping manner in the frame clamp by tightening of the bracing screw 28. Via the second joint arm 20 which is configured as a frame clamp, the articulated connector device 1 can be fastened, for example, to a rod of a subframe of a wheelchair.

By pivoting the joint arms 10, 20 with respect to the connecting arm 30, an orientation of the padding 15 with respect to the second joint arm 20 can take place. If the second joint arm 20 is fastened to a wheelchair, the padding 15 can be oriented with respect to the wheelchair in this way for the purpose of setting up the padding 15.

In order to fix the first joint arm 10 and the second joint arm 20 with respect to the connecting arm 30 in the desired pivot position for the purpose of fixing the padding 15 in the desired position, the articulated connector device 1 has a clamping unit 40. The clamping unit 40 per se is shown in FIG. 6 in a preassembled state.

The clamping unit 40 has a front clamping jaw 41 and a rear clamping jaw 42. The clamping jaws 41, 42 can be fed in towards one another along an infeed direction Z1 for simultaneous fixing of the first joint arm 10 and the second joint arm 20 in the respective pivot position with respect to the connecting arm 30 in a single step. In the present case, the infeed direction Z1 runs perpendicularly with respect to a plane defined by the pivot axes A1, A2. The feeding in and releasing of the front clamping jaw 41 with respect to the rear clamping jaw 42 takes place via a screwing element 43. The spring element 43 is configured as a screw and has a threaded portion 44, wherein the spring element 43 passes through a through opening 46 of the rear clamping jaw 43 and is screwed into a mating threaded portion 45 which is configured in the front clamping jaw 41. A washer 99 is arranged between the head of the screwing element 43 and the rear clamping jaw 42.

The clamping unit 40 is mounted in a floating and captive manner in the connecting arm 30. The floating and captive mounting of the clamping unit 40 in the connecting arm 30 is brought about by virtue of the fact that the connecting arm 30 has an upper portion 31, a lower portion 32 which is spaced apart from the upper portion 31 along the axial direction of the axes A1, A2 and runs parallel to the upper portion 31, and a connecting portion 33 which connects the upper portion 31 to the lower portion 32. This connecting portion 33 has a through opening 34, wherein the screw of the screwing element 43 and the washer 99 are received in this through opening. The rear clamping jaw 42 is received captively between the first bearing portion 11, the second bearing portion 21, the upper portion 31, the lower portion 32 and the connecting portion 33 with a play in all spatial directions, as a result of which the floating and the captive mounting of the clamping unit 40 in the connecting arm 30 is brought about.

As has already been stated, the joint arms 10, 20 can be fixed in the respective pivot position with respect to the connecting arm 30 such that they cannot rotate via feeding in of the front clamping jaw 41 and the rear clamping jaw 42 towards one another, brought about by tightening the screwing element 43, and therefore a single fixing operation. For this purpose, the first bearing portion 11 has a convexly curved first clamping surface 12 which runs concentrically with respect to the first pivot axis A1. Here, the first clamping surface 12 follows the shell surface of a circular cylinder. The front clamping jaw 41 has a first mating clamping surface 411 which corresponds to the first clamping surface 12, and the rear clamping jaw 42 has a further first mating clamping surface 421 which corresponds to the first clamping surface 12. The first mating clamping surface 411 and the further first mating clamping surface 421 are concavely curved in a complementary manner with respect to the first clamping surface 12, in such a way that, when the clamping jaws 41, 42 are fed in towards one another, the first mating clamping surface 411 and the further first mating clamping surface 421 each come into contact over their full area with the first clamping surface 12 and interact with the latter in a non-positive manner. As a result, fixing of the first joint arm 10 with respect to the connecting arm 30 such that it cannot rotate is achieved.

In an analogous manner with respect to this, the second bearing portion 21 has a convexly curved second clamping surface 22 which runs concentrically with respect to the second pivot axis A2 and once again follows the shell surface of a circular cylinder. The front clamping jaw 41 has a second mating clamping surface 412, and the rear clamping jaw 42 has a further second mating clamping surface 422. The second mating clamping surface 412 and the further second mating clamping surface 422 are each concavely curved in a complementary manner with respect to the second clamping surface 22. When clamping jaws 41, 42 are fed in towards one another, the second mating clamping surface 412 and the further second mating clamping surface 422 each bear over their full area against the second clamping surface 22 and interact with the latter in a non-positive manner in order to fix the second joint arm 20 with respect to the connecting arm 30 such that it cannot rotate.

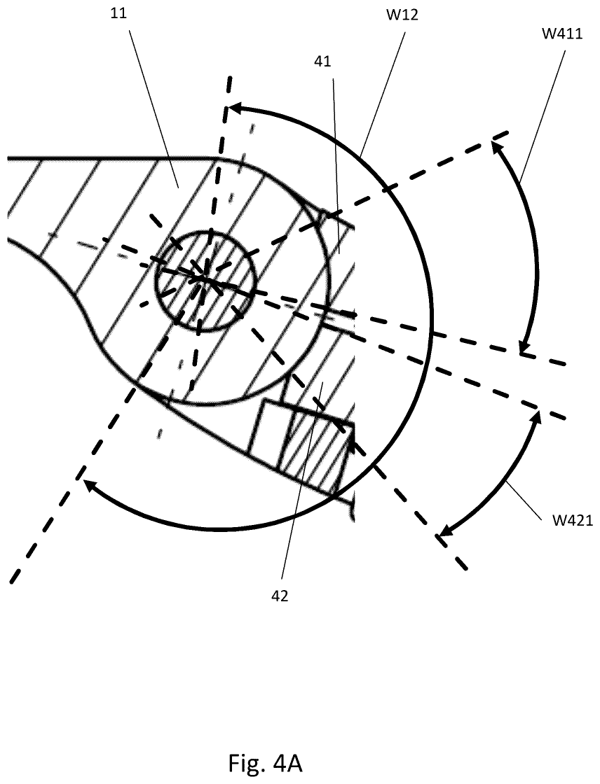

It becomes clear in the cross section which is shown in FIG. 4 and in FIG. 4A that the first clamping surface 12, the first mating clamping surface 411 and the further first mating clamping surface 421 each describe a circular arc with an identical first radius. In the clamping position or in the position of the first clamping jaw 41 and the second clamping jaw 42 in which they are fed in towards one another, the circle centre points of the circular arcs coincide and lie in the first pivot axis A1. While the circular arc of the first clamping surface 12 describes a centre angle W12 of greater than 180°, a sum of a centre angle W411 of the first mating clamping surface 411 and a centre angle W421 of the further first mating clamping surface 421 is smaller than 100°. This can be gathered, in particular, from FIG. 4A. This applies correspondingly to the second clamping surface 22, the second mating clamping surface 412 and the further second mating clamping surface 422.

As can be gathered, in particular, from FIG. 4, the front clamping jaw 41 and the rear clamping jaw 42 are designed in such a way that the front clamping jaw 41 and the rear clamping jaw 42 are spaced apart from one another in the infeed direction Z1 in the position shown in FIG. 4, in which they are fed in towards one another. Accordingly, a gap 70 between the front clamping jaw 41 and the rear clamping jaw 42 in the infeed direction 71 results in the position of the clamping jaws 41, 42 in which they are fed in towards one another. In a cross section perpendicularly with respect to the pivot axes A1, A2 (shown in FIG. 4), the gap 70 has a first end portion which adjoins the first bearing portion 11 and a second end portion which adjoins the second bearing portion 21. These two end portions of the gap 70 lie on a rectilinear connecting line L1 between the first pivot axis A1 and the second pivot axis A2.

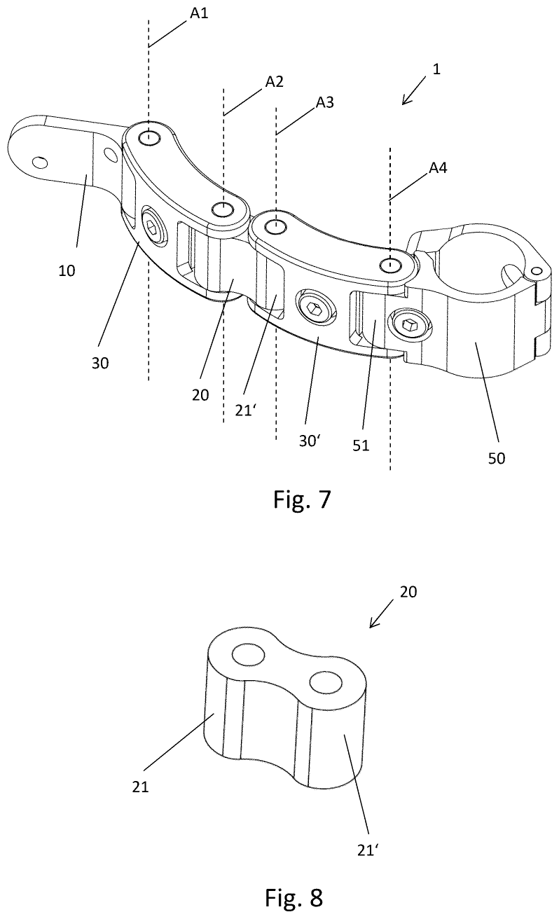

FIG. 7 shows an articulated connector device 1 in accordance with the second embodiment in a perspective illustration. This differs from the first embodiment substantially in that the connector device has a further connecting arm 30′. The second joint arm 20 is configured as an intermediate arm and has a further second bearing portion 21′, by way of which the second joint arm 20 is mounted in the further connecting arm 30′ pivotably about a third pivot axis A3. Furthermore, a third joint arm 50 is mounted pivotably to the further connecting arm 30′. For this purpose, the third joint arm 50 has a third bearing portion 51, by way of which the third joint arm 50 is mounted in the further connecting arm 30′ pivotably about a fourth pivot axis A4. The third joint arm 50 is configured as a frame clamp. A further clamping unit is mounted in the further connecting arm 30′ for fixing the second joint arm 20 and the third joint arm 50 in their respective pivot position with respect to the further connecting arm 30′. The method of operation of the further clamping unit which is mounted in the further connecting arm 30′ and its interaction with the further connecting arm 30′, the further second bearing portion 21′ and the third bearing portion 51 correspond to that of the clamping unit 40 which is mounted in the connecting arm 30 and its interaction with the connecting arm 30, the second bearing portion 21 and the third bearing portion 11. The second joint arm 20 of the second embodiment is shown isolated in FIG. 8.

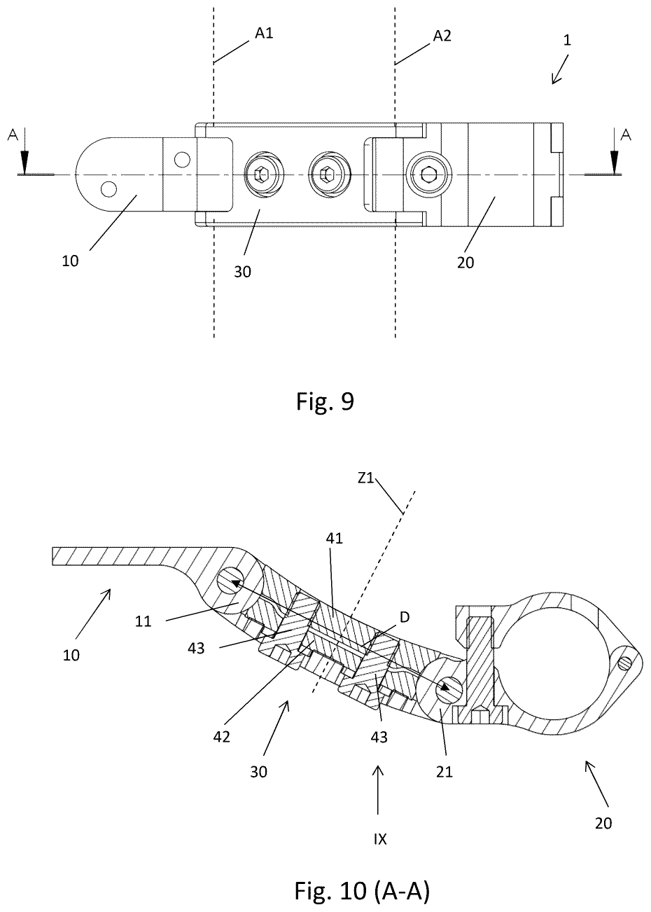

FIGS. 9 and 10 show an articulated connector device 1 in accordance with a third embodiment. This differs from the first embodiment substantially by way of the design of the connecting arm 30 and the clamping unit 40. The connecting arm 30 of the third embodiment is of longer configuration in the connecting arm 30 of the first embodiment, with the result that the spacing D of the first pivot axis A1 from the second pivot axis A2 is greater in the third embodiment than in the first embodiment. Accordingly, the clamping unit 40 of the third embodiment is also of longer configuration than the clamping unit 40 of the first embodiment. In order to ensure that a sufficient pressing force and therefore a sufficient non-positive connection for fixing the joint arms 10, 20 such that they cannot rotate can be applied by the clamping jaws 41, 42 in the case of the respective bearing axle 11, 21, the screw connection in accordance with the third embodiment does not have a single central screwing element 43, but rather two screwing elements 43. The one screwing element 43 is configured adjacently with respect to the first bearing portion 11, and the other screwing element 43 is configured adjacently with respect to the second bearing portion 21.

### LIST OF REFERENCE SIGNS

1 Articulated connector device
10 First joint arm
11 First bearing portion
12 First clamping surface
15 Padding
20 Second joint arm
21 Second bearing portion
21 Further second bearing portion
22 Second clamping surface
26 Joint clamping half
27 Bracing clamping half
28 Bracing screw
30 Connecting arm
30 Further connecting arm
31 Upper portion
32 Lower portion
33 Connecting portion
34 Through opening
40 Clamping unit
41 Front clamping jaw
42 Rear clamping jaw
43 Screwing element
44 Threaded portion
45 Mating threaded portion
46 Through opening
50 Third joint arm
51 Third bearing portion
70 Gap
80 Cylindrical pin
81 Through bore
83 Through bore
99 Washer
100 Padding holder
411 First mating clamping surface
412 Second mounting clamping surface
421 Further first mating clamping surface
422 Further second mating clamping surface
A1 First pivot axis
A2 Second pivot axis
A3 Third pivot axis
A4 Fourth pivot axis
D Spacing
L1 Connecting line
Z1 Infeed direction
W12 Centre angle
W411 Centre angle
W421 Centre angle

1. Articulated connector device, wherein the connector device has a first joint arm, a second joint arm and a connecting arm, wherein the first joint arm has a first bearing portion, wherein the first joint arm is mounted with its first bearing portion in the connecting arm pivotably about a first pivot axis, and wherein the second joint arm has a second bearing portion, wherein the second joint armis mounted with its second bearing portion in the connecting arm pivotably about a second pivot axis, wherein the first pivot axis and the second pivot axis (run parallel to one another, wherein the connector device has a clamping unit, wherein the clamping unit is mounted in the connecting arm, wherein the clamping unit has a front clamping jaw and a rear clamping jaw, wherein the clamping jaws can be fed in towards one another along an infeed direction for fixing the first joint arm and the second joint arm in their respective pivot position with respect to the connecting arm,
wherein the first bearing portion has a convexly curved first clamping surface which runs concentrically with respect to the first pivot axis, wherein the front clamping jaw has a first mating clamping surface, and the rear clamping jaw has a further first mating clamping surface, wherein the first mating clamping surface and the further first mating clamping surface are concavely curved in each case in a complementary manner with respect to the first clamping surface, in such a way that, when the clamping jaws are fed in towards one another, the first mating clamping surface and the further first mating clamping surface come into contact in each case over their full area with the first clamping surface and interact in a non-positive manner with the latter for fixing the first joint arm such that it cannot rotate with respect to the connecting arm,
wherein the second bearing portion has a convexly curved second clamping surface which runs concentrically with respect to the second pivot axis, wherein the front clamping jaw has a second mating clamping surface, and the rear clamping jaw has a further second mating clamping surface, wherein the second mating clamping surface and the further second mating clamping surface are concavely curved in each case in a complementary manner with respect to the second clamping surface, in such a way that, when the clamping jaws are fed in towards one another, the second mating clamping surface (412) and the further second mating clamping surface come into contact in each case over their full area with the second clamping surface and interact in a non-positive manner with the latter fixing the second joint arm such that it cannot rotate with respect to the connecting arm.

2. Articulated connector device according to claim 1, wherein, in a cross section perpendicularly with respect to the pivot axes, the first clamping surface, the first mating clamping surface and the further first mating clamping surface each describe a circular arc with an identical first radius, and/or wherein, in a cross section perpendicularly with respect to the pivot axes, the second clamping surface, the second mating clamping surface and the further second mating clamping surface each describe a circular arc with an identical second radius.

3. Articulated connector device according to claim 1, wherein a sum of the centre angles of the circular arcs described by the first mating clamping surface and the further first mating clamping surface is smaller than 180°, is preferably smaller than 120°, is particularly preferably smaller than 100°, and/or wherein a sum of the centre angles of the circular arcs described by the second mating clamping surface and the further second mating clamping surface is smaller than 180°, is preferably smaller than 120°, is particularly preferably smaller than 100°.

4. Articulated connector device according to claim 1, wherein the connecting arm has an upper portion, and a lower portion which is spaced apart along the axial direction of the pivot axes, and a connecting portion which connects the upper portion to the lower portion.

5. Articulated connector device according to claim 4, wherein the rear clamping jaw is received captively between the first bearing portion, the second bearing portion, the upper portion, the lower portion and the connecting portion.

6. Articulated connector device according to claim 5, wherein the rear clamping jaw is received in a floating manner between the first bearing portion, the second bearing portion, the upper portion, the lower portion and the connecting portion.

7. Articulated connector device according to claim 1, wherein the front clamping jaw and the rear clamping jaw are designed in such a way that the front clamping jaw and the rear clamping jaw are spaced apart from one another in the infeed direction in the position, in which they are fed in towards one another.

8. Articulated connector device according to claim 7, wherein there is a gap between the front clamping jaw and the rear clamping jaw in the position of the clamping jaws, in which they are fed in towards one another, wherein, in a cross section perpendicularly with respect to the pivot axes, a first end portion of the gap which adjoins the first bearing portion and a second end portion of the gap which adjoins the second bearing portion (21) lie in a connecting line between the first pivot axis and the second pivot axis.

9. Articulated connector device according to claim 1, wherein the clamping unit has a screw connection which acts between the front clamping jaw and the rear clamping jaw for feeding in the clamping jaws towards one another by tightening the screw connection.

10. Articulated connector device according to claim 9, wherein the screw connection has at least one screwing element with a threaded portion, wherein one clamping jaw of the clamping jaws has at least one mating threaded portion, to which the at least one screwing element is screwed by way of its threaded portion.

11. Articulated connector device according to claim 10, wherein the at least one screwing element is configured with a screw with an external thread as threaded portion, and the at least one mating threaded portion of the one clamping jaw is configured as an internal thread, wherein the at least one screw passes through the other clamping jaw.

12. Articulated connector device according to claim 10, wherein, in cross section perpendicularly with respect to the pivot axes, the one clamping jaw has a greater material thickness in the region of the at least one internal thread than in the adjoining regions.

13. Articulated connector device according to claim 12, wherein, in a cross section perpendicularly with respect to the pivot axes, the one clamping jaw has a projection in the region of the at least one internal thread on its side which faces the other clamping jaw, and the other clamping jaw has a recess which corresponds to the projection.

14. Articulated connector device according to claim 8, wherein the screw connection is designed in such a way that, when the screw connection is tightened, exclusively the front clamping jaw and the rear clamping jaw are fed in relative to one another, and, in particular, no supporting of the clamping jaws on one another and/or on the connecting arm occurs in the intake direction.

15. Padding holder comprising an articulated connector device according to Claim 1, wherein the first pivot arm has a padding or is connected to a padding, wherein the second pivot arm has a fastening device for fastening the padding holder to a frame.
